(19) United States
(12) Patent Application Publication
(10) Pub. No.: US 2005/0060453 A1
(43) Pub. Date: Mar. 17, 2005

(54) Instruction supply control unit and semiconductor device

(75) Inventors: Toru Matsui, Kyoto (JP); Atsushi Kotani, Osaka (JP)

Correspondence Address: Jack Q. Lever, Jr.;McDERMOTT, WILL & EMERY, 600 Thirteenth Street, N.W., Washington, DC, 20005-3096, US

(73) Assignee: MATSUSHITA ELECTRIC INDUSTRIAL CO., LTD.

(21) Appl. No.: 10/832,426

(22) Filed: Apr. 27, 2004

(30) Foreign Application Priority Data
Aug. 20, 2003 (JP) 2003-296088

(51) Int. Cl. G06F 13/00; G06F 13/36

(52) U.S. Cl. 710/107

(57) ABSTRACT

The instruction supply control unit of this invention for appropriately selecting one master to be given a bus use right from a plurality of masters and supplying instructions issued by the selected master to the bus includes an instruction group end detection part for detecting the end of each instruction group composed of a batch of instructions issued by the selected master, and an arbitration part for giving the bus use right to the selected master until the instruction group end detection part detects the end of the instruction group.

### BACKGROUND OF THE INVENTION

The present invention relates to an instruction supply control unit for controlling priority of a bus use right among a plurality of master processing units (hereinafter referred to as “masters”), and more particularly, it relates to a technique to control priority of instruction supply suitably employed in a system in which two or more masters issue instructions to a plurality of functional blocks connected to one bus.

In conventional technique, with respect to arbitration among a plurality of masters, a difference in the execution time required for executing a program is minimized in consideration of idle holding time necessary for bus arbitration performed in deciding priority of bus use. FIG. 10 shows the architecture of a conventional bus use priority control unit. In this control unit, a first register 42 obtains a cumulative value of the idle holding times required for the arbitration for bus use among masters 20-1 through 20-N, and a comparator 44 compares the obtained cumulative value with a reference value stored in a second register 43. When the cumulative value is larger than the reference value, the priority of the corresponding master 20 for using the bus is increased. In this manner, a difference in the time necessary for acquiring the bus use among the masters is reduced (for example, see Japanese Laid-Open Patent Publication No. 6-96014 (p. 5 and FIG. 1)).

In the conventional bus arbitration technique, the bus use right may be shifted to another master in the middle of processing of an instruction group consisting of a batch of instructions issued by one master. An instruction group, which corresponds to a substantial processing unit for each master, cannot produce a useful result until respective instructions included in the instruction group are successively and continuously executed. Therefore, when the bus use right is shifted to another master during the processing of one instruction group, the master having issued the instruction group takes a comparatively long period of time to obtain the processing result of the instruction group, which lowers the processing efficiency of the whole system. Furthermore, when the instruction group requires continuous instruction execution, suspension of the processing can cause a fatal system error.

### SUMMARY OF THE INVENTION

In consideration of the aforementioned conventional problem, an object of the invention is, in an instruction supply control unit for appropriately selecting a master to be given a bus use right from a plurality of masters and supplying instructions issued by the selected master to a bus, guaranteeing successiveness and continuity of processing of an instruction group issued by each master by switching the bus use right with respect to each instruction group. Another object is providing a semiconductor device that includes such an instruction supply control unit and can switch an access right among a plurality of externally connected masters with respect to each instruction group.

In order to achieve the objects, the instruction supply control unit of this invention for appropriately selecting a master to be given a bus use right from a plurality of masters and supplying instructions issued by the selected master to the bus, includes an instruction group end detection part for detecting an end of an instruction group composed of a batch of instructions issued by the selected master; and an arbitration part for giving the bus use right to the selected master until the end of the instruction group is detected by the instruction group end detection part.

In this instruction supply control unit, the instruction group end detection part detects the end of each instruction group composed of instructions issued by a master having the bus use right. On the other hand, the arbitration part keeps the bus use right given to this master until the end of the instruction group is detected. In other words, the bus use right is never shifted to another master until the end of the instruction group is detected. In this manner, the bus use right is switched with respect to each instruction group, so as to guarantee successiveness and continuity of the processing of each instruction group issued by each master.

Specifically, each instruction issued by the plurality of masters includes an instruction end bit indicating whether or not the instruction is an end of a corresponding instruction group, and the instruction group end detection part detects the end of the instruction group when the instruction end bit has a given value.

Preferably, the instruction supply control unit further includes a buffer part for storing instructions issued by each of the plurality of masters, and when the instruction group end detection part detects the end of the instruction group, the arbitration part reads the instructions stored in the buffer part, supplies the read instructions to the bus and releases the bus use right of the selected master having issued the instructions.

In the case where the instruction supply control unit thus includes the buffer part for storing instructions issues by each master, when the bus use right is shifted to another master, instructions issued by this master having newly obtained the bus use right are rapidly read from the buffer part, resulting in improving the processing speed.

More preferably, instructions issued by two masters are supplied to the bus, and the buffer part includes a FIFO that stores instructions issued by one of the two masters from a starting address in the order of increasing addresses and stores instructions issued by the other of the two masters from an end address in the order of reducing addresses.

In the case where instructions are thus stored in the FIFO shared by the two masters, the storage area is more efficiently used than in the case where the two masters are respectively provided with dedicated buffers.

Also, more preferably, the buffer part includes a register for adjusting an effective storage area of the buffer part.

When the effective storage area of the buffer part can be thus adjusted, the method for executing an instruction can be changed in accordance with the characteristic of the instruction. For example, in the case where batch processing of massive instructions is significant, the effective storage area is increased for storing massive instructions in the buffer part, so that the massive instructions can be supplied to the bus in a batch. Alternatively, in the case where continuity of the execution of the instructions is significant, the effective storage area is reduced for storing few instructions in the buffer part, so that an instruction can be supplied to the bus every time it is issued by the master.

Alternatively, the semiconductor device of this invention includes at least one internal master; an internal bus; at least one functional block connected to the internal bus; an interface unit for appropriately selecting an external master to be given an access right to access the semiconductor device from a plurality of external masters connected to the semiconductor device; and an instruction supply control unit for appropriately selecting a master to be given an internal bus use right from the at least one internal master and the external master selected by the interface unit and supplying instructions issued by the selected master to the internal bus. In this semiconductor device, the instruction supply control unit includes an instruction group end detection part for detecting an end of an instruction group composed of a batch of instructions issued by the selected master; and an arbitration part for giving the internal bus use right to the selected master until the instruction group end detection part detects the end of the instruction group. Furthermore, the interface unit gives the selected external master the access right to access the semiconductor device until the instruction group end detection part detects an end of an instruction group issued by the selected external master.

In this semiconductor device, the access right to access the semiconductor device, namely, the use right of the internal bus, is switched between external masters with respect to each instruction group. Accordingly, also with respect to the external masters, the successiveness and the continuity of the processing of each instruction group issued by each external master are guaranteed.

Specifically, each instruction issued by the at least one internal master and the external master selected by the interface unit includes an instruction end bit indicating whether or not the instruction is an end of a corresponding instruction group, and the instruction group end detection part detects the end of the instruction group when the instruction end bit has a given value.

Preferably, the semiconductor device further includes a buffer part for storing instructions issued by each of the at least one internal master and the external master selected by the interface unit, and when the instruction group end detection part detects the end of the instruction group, the arbitration part reads the instructions stored in the buffer part, supplies the read instructions to the internal bus and releases the internal bus use right of the selected master having issued the instructions.

In this manner, according to this invention, the bus use right is switched between masters with respect to each instruction group. Accordingly, the successiveness and the continuity of the processing of each instruction group issued by each master are guaranteed, resulting in improving the performance of the whole system.

### BRIEF DESCRIPTION OF THE DRAWINGS

FIG. 1 is a schematic diagram for showing the architecture of a system including an instruction supply control unit according to Embodiment 1 of the invention;

FIG. 2 is a diagram for showing the internal architecture of the instruction supply control unit of Embodiment 1 of the invention;

FIG. 3 is a diagram of a bit configuration of an instruction code including an instruction end bit;

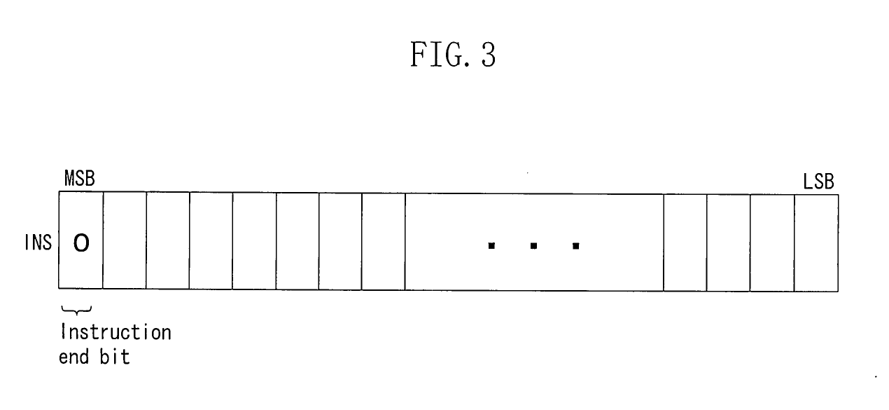

FIG. 4 is a schematic diagram for showing the architecture of a system including an instruction supply control unit according to Embodiment 2 of the invention;

FIG. 5 is a diagram for showing the internal architecture of the instruction supply control unit of Embodiment 2 of the invention;

FIG. 6 is a schematic diagram for showing the architecture of a semiconductor device according to Embodiment 3 of the invention;

FIG. 7 is a diagram for showing the internal architecture of an interface unit of the semiconductor device of FIG. 6;

FIG. 8 is a timing chart of the interface unit of the semiconductor device of FIG. 6;

FIG. 9 is another timing chart of the interface unit of the semiconductor device of FIG. 6; and

FIG. 10 is a diagram for showing the architecture of a conventional bus use priority control unit.

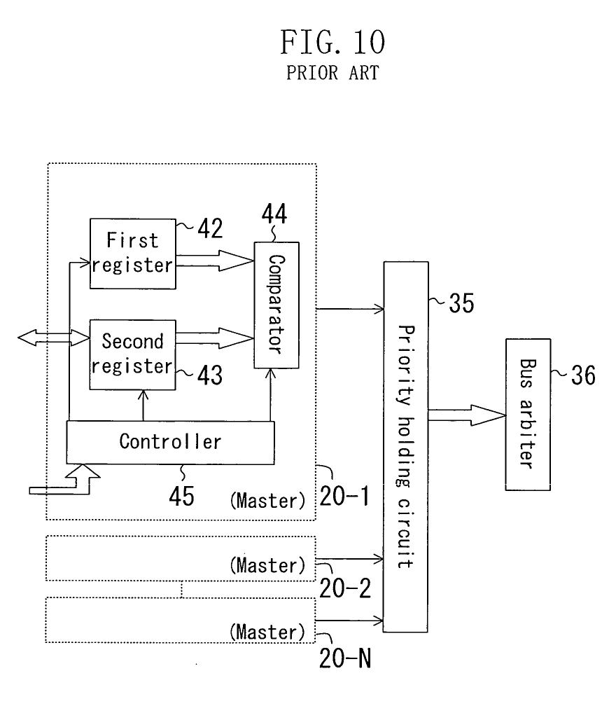

### DETAILED DESCRIPTION OF THE INVENTION

Preferred embodiments of the invention will now be described with reference to the accompanying drawings.

Embodiment 1

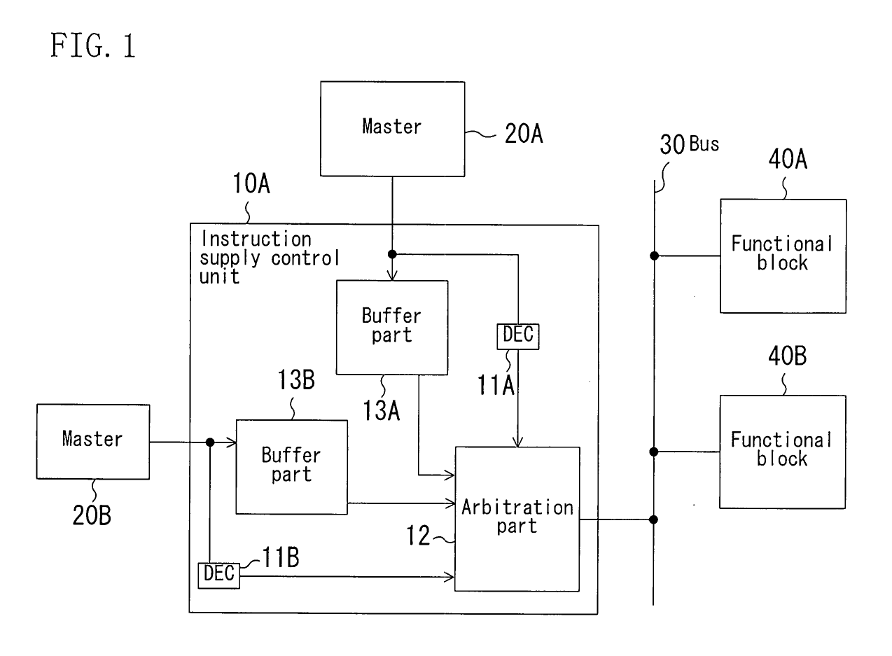

FIG. 1 schematically shows the architecture of a system including an instruction supply control unit according to Embodiment 1 of the invention. The instruction supply control unit 10A of this embodiment appropriately selects, from masters 20A and 20B, a master to be given a right to use a bus 30, and supplies instructions issued by the selected master to the bus 30. The bus 30 is connected to functional blocks 40A and 40B serving as slaves, and each of the masters 20A and 20B can make an access to the functional blocks 40A and 40B when the right to use the bus 30 is given by the instruction supply control unit 10A. The bus 30 may be an internal bus or an external bus. Also, an arbitrary number of functional blocks may be connected to the internal bus 30.

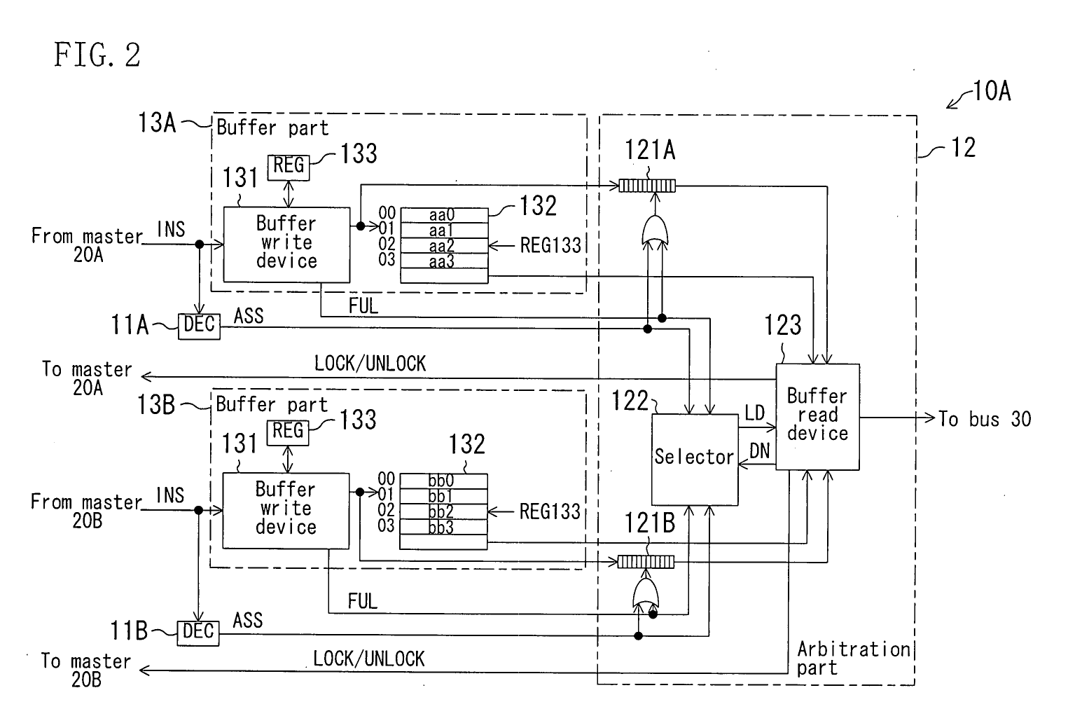

The instruction supply control unit 10A includes decoders 11A and 11B serving as instruction group end detection parts for respectively detecting the ends of instruction groups issued by the masters 20A and 20B, an arbitration part 12 for arbitrating the bus use right, and buffer parts 13A and 13B for respectively temporarily storing instructions issued by the masters 20A and 20B. FIG. 2 shows the internal configuration of the instruction supply control unit 10A. Now, the architecture of the instruction supply control unit 10A will be described in detail with reference to FIG. 2.

The decoders 11A and 11B respectively successively accept and decode instruction codes INS issued by the masters 20A and 20B, and output an assert signal ASS when the end of an instruction group is detected. At this point, the MSB (Most Significant Bit) of each instruction code INS is allocated to an instruction end bit for indicating whether or not the corresponding instruction is the end of the instruction group. Accordingly, each of the decoders 11A and 11B can easily detect the end of the instruction group by monitoring the MSB of the decoded instruction code INS.

It is noted that the instruction end bit may be allocated to an arbitrary bit of the instruction code INS apart from the MSB. Alternatively, without allocating the instruction end bit, each of the decoders 11A and 11B may output the assert signal ASS, for example, when issue of a given instruction such as “HALT” indicating the end of the instruction group is detected.

Referring to FIG. 2 again, each of the buffer parts 13A and 13B includes a buffer write device 131, a buffer 132 and a register 133. The buffer write device 131 stores issued instruction codes in the buffer 132 in the order of issue. When the instruction codes are stored to fill up the buffer capacity of the buffer 132, the buffer write device 131 outputs a signal FUL corresponding to a full state of the buffer. The buffer 132 can store the instruction codes in the buffer capacity up to the maximum address indicated by the register 133. In other words, the quantity of instructions that can be stored in the buffer 132 can be adjusted by setting the register 133. For example, when the register 133 stores address data “10”, the buffer capacity of the buffer 132 is from an address “00” to an address “10”. The register 133 can be set through instruction from the master 20A or 20B by, for example, describing appropriate information in the header of an instruction issued by the master 20A or 20B. Needless to say, the register 133 can be directly set by a user.

On the other hand, the arbitration part 12 includes registers 121A and 121B for storing the addresses of the buffers 132, a selector 122 for selecting a master to be allowed to use the bus 30, and a buffer read device 123 for reading the instruction codes stored in the buffers 132 and supplying the read instruction codes to the bus 30. When the registers 121A and 121B receive either the signal ASS or the signal FUL from the buffer parts 13A and 13B, respectively, namely, when they receive a logical OR signal of the signal ASS and the signal FUL, they hold the addresses of the corresponding buffers 132 attained at that point. When the selector 122 receives the signal ASS or the signal FUL, it outputs a signal LD for instructing the buffer read device 123 to read the instructions. When the buffer read device 123 receives the signal LD, it supplies the instructions issued by the master selected by the selector 122 from the corresponding buffer 132 to the bus 30. Specifically, the buffer read device 123 reads instructions stored in the corresponding buffer 132 from the starting address to the address indicated by the corresponding register 121A or 121B.

Next, the operation of the instruction supply control unit 10A will be described with reference to FIG. 2.

It is assumed that the master 20A is selected by the selector 122, namely, the master 20A has the bus use right. Furthermore, it is assumed that the buffer 132 of the buffer part 13A stores instruction codes “aa0”, “aa1”, “aa2” and “aa3” in the addresses “00” through “03”. At this point, when an instruction code INS corresponding to the end of the instruction group is input from the master 20A, the decoder 11A outputs the signal ASS. The register 121A holds the address “04” of the buffer 132 attained at this point.

When the selector 122 receives the signal ASS, it outputs the signal LD to the buffer read device 123. When the buffer read device 123 receives the signal LD, it reads the instructions stored in the buffer 132 of the buffer part 13A from the starting address “00” to the address “04” indicated by the register 121A and supplies the read instructions to the bus 30. At this point, the buffer read device 123 outputs a signal LOCK to the master 20A, so as to temporarily suspend instruction supply from the master 20A for avoiding storage of new instructions in the buffer 132 of the buffer part 13A. Then, after completing reading the instructions from the buffer 132, the buffer read device 123 outputs a signal UNLOCK to the master 20A, so as to allow the master 20A to resume the instruction supply.

It is noted that the buffer part 13B can receive and store instruction codes INS issued by the master 20B while the buffer read device 123 is reading and supplying the instructions. In other words, each master can issue instructions and store them in the corresponding buffer part even when it does not have the bus use right. Accordingly, the instructions stored in the buffer part can be simply read when the bus use right is given, and thus, the processing speed is increased.

When the buffer read device 123 completes reading the instructions from the buffer 132, it outputs a signal DN to the selector 122. When the selector 122 receives the signal DN, it shifts the bus use right to another master (that is, the master 20B in this case). Conversely speaking, even if the selector 122 receives the signal ASS from a master not selected (that is, the master 20B in this case), it never shifts the bus use right unless it receives the signal DN from the buffer read device 123.

In this exemplified operation, the selector 122 receives the signal ASS, and the instruction supply control unit is operated similarly also when the selector 122 receives the signal FUL. In this case, however, the selector 122 never shifts the bus use right to another master even when it receives the signal DN but keeps the bus use right given to the selected master until the signal ASS is received from the selected master. In this manner, the bus use right is definitely switched with respect to each instruction group.

As described so far, according to this embodiment, the bus use right is switched between the respective masters with respect to each instruction group, so that successiveness and continuity of processing of each instruction group can be guaranteed. The instruction supply control unit 10A switches the bus priority between the two masters 20A and 20B in this embodiment, which does not limit the invention. According to this invention, the bus priority can be switched also among three or more masters with respect to each instruction group.

In the aforementioned architecture, the register 133 may be omitted with the buffer capacity of the buffer 132 fixed to a given value. However, the register 133 is preferably provided so that the buffer capacity can be adjusted. Thus, for example, in the case where massive data such as audio data is captured in a batch and processed at a comparatively slow rate of less thanl00 KHz, the buffer capacity of the buffer 132 may be set to a large value. On the contrary, in the case of, for example, graphic data that are necessary to process with respect to each line of a screen, the buffer capacity may be set to a small value so as to supply instructions without a break.

Furthermore, in the aforementioned architecture, the buffer parts 13A and 13B may be particularly omitted. The instruction supply control unit 10A can switch the bus use right between the respective masters with respect to each instruction group without using the buffer parts 13A and 13B.

Embodiment 2

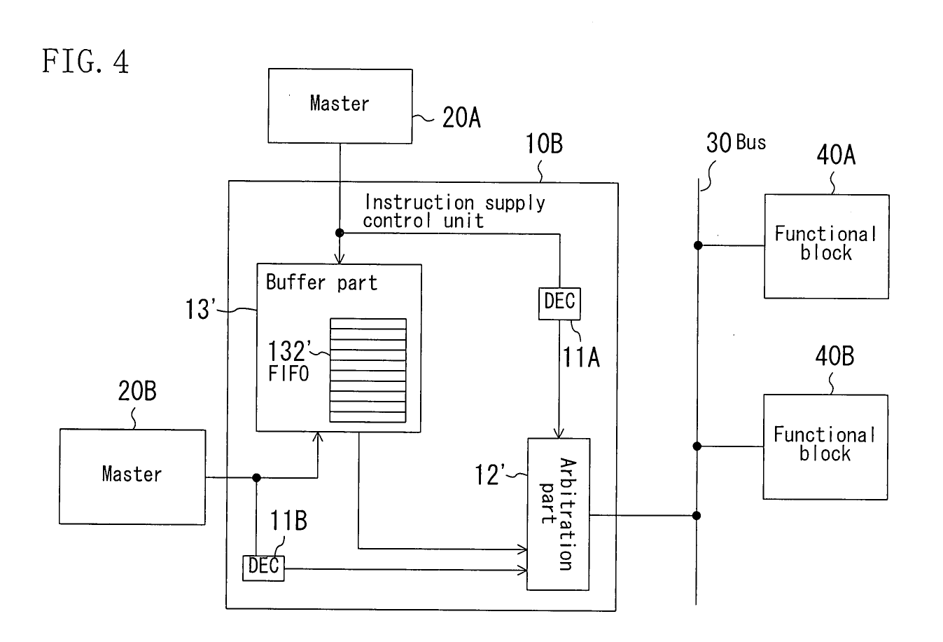

FIG. 4 schematically shows the architecture of a system including an instruction supply control unit according to Embodiment 2 of the invention. Similarly to the instruction supply control unit 10A of Embodiment 1, the instruction supply control unit 10B of this embodiment appropriately selects, from masters 20A and 20B, a master to allow to use a bus 30, and supplies instructions issued by the selected master to the bus 30. Differently from the instruction supply control unit 10A, however, the instruction supply control unit 10B includes a buffer part 13′ having a FIFO 132′ for storing instructions issued by the masters 20A and 20B, and an arbitration part 12′. Now, the instruction supply control unit 10B will be described merely with respect to differences from the instruction supply control unit 10A.

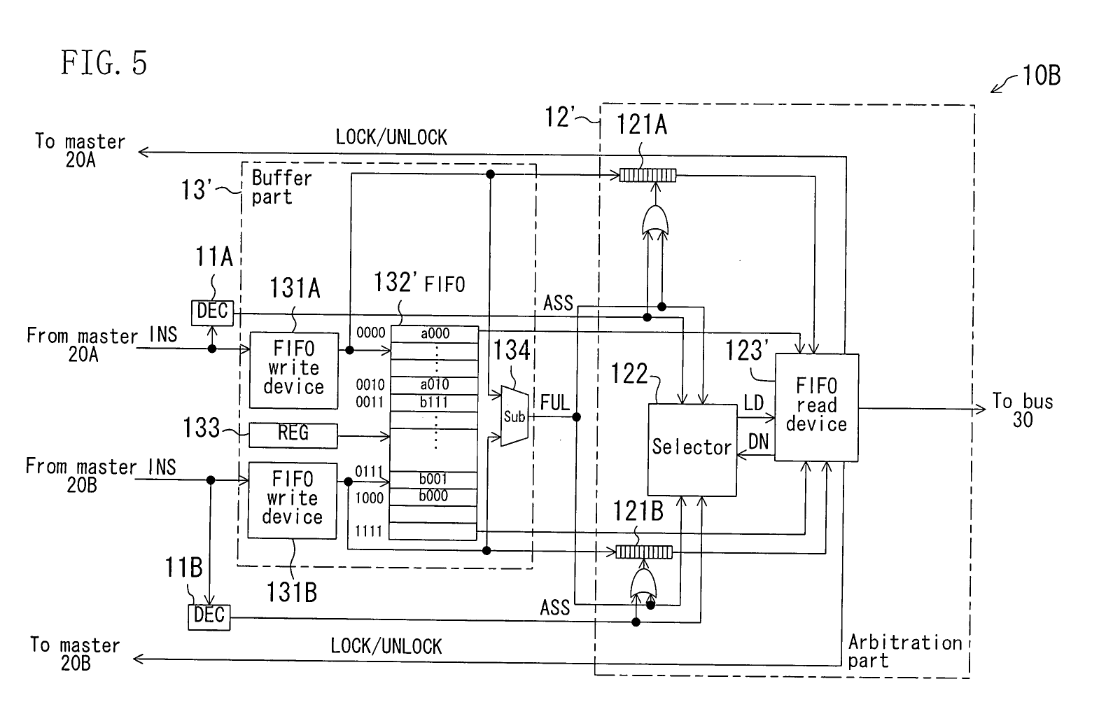

FIG. 5 shows the internal architecture of the instruction supply control unit 10B. The buffer part 13′ includes a FIFO write devices 131A and 131B, the FIFO 132′, a register 133 and a subtracter 134. The FIFO write device 131A stores instruction codes issued by the master 20A in the FIFO 132′ successively in the order of the issue from the starting address in the order of increasing addresses. On the other hand, the FIFO write device 131B stores instruction codes issued by the master 20B in the FIFO 132′ successively in the order of the issue from the end address in the order of reducing addresses.

The end address of the FIFO 132′ is given by the register 133. In other words, the effective storage area of the FIFO 132′ can be adjusted by appropriately setting the register 133. For example, when the register 133 stores address data “1000”, the FIFO write device 131B starts storing the instructions in the FIFO 132′ from an address “1000”. The register 133 can be set through the instruction from the master 20A or 20B by, for example, describing appropriate information in the header of an instruction issued by the master 20A or 20B. Needless to say, the register 133 can be directly set by a user.

The subtracter 134 monitors whether or not the buffer capacity of the FIFO 132′ is filled up. When it detects that the buffer capacity is filled up, it outputs a signal FUL indicating a full state of the FIFO. Specifically, the subtracter 134 calculates a difference between a currently written address “ADR_A” of the FIFO write device 131A and a currently written address “ADR_B” of the FIFO write device 131B, namely, (ADR_B-ADR_A), and outputs the signal FUL when the calculation result is “1”. For example, when instruction codes “a000” through “a010” issued by the master 20A are written in addresses from “0000” to “0010” and instruction codes “b000” through “bill” issued by the master 20B are written in addresses from “1000” to “0011” as shown in FIG. 5, the difference between the addresses is “1”, and hence, the subtracter 134 outputs the signal FUL.

On the other hand, when a FIFO read device 123′ of the arbitration part 12′ receives a signal LD from a selector 122, it reads the instruction codes stored from the starting address to the address indicated by the register 121A with respect to the instructions issued by the master 20A. Alternatively, the instruction codes stored from the address indicated by the register 133 to the address indicated by the register 121B are read with respect to the instructions issued by the master 20B.

Differently from the buffer read device 123 of Embodiment 1, the FIFO read device 123′ outputs a signal LOCK to the masters 20A and 20B when it receives the signal LD, so as to temporarily suspend the instruction issue. This is because if the master 20B is allowed to write instructions in the FIFO 132′ while the instructions issued by the master 20A are being read from the FIFO 132′, the FIFO 132′ may be disadvantageously filled up with instructions issued by the master 20B. When the FIFO 132′ is filled up with the instructions issued by the master 20B, the master 20A cannot store its instructions in the FIFO 132′ even after receiving a signal UNLOCK. Furthermore, the bus use write is never shifted to the master 20B unless the supply of the instruction group issued by the master 20A is completed. Accordingly, what is called dead lock is caused in this case. Then, after completing reading the instructions from the FIFO 132′, the FIFO read device 123′ outputs the signal UNLOCK to the masters 20A and 20B, so as to allow them to resume the instruction issue.

Instead of employing the aforementioned method using the signal LOCK output to the masters 20A and 20B, a private area of each master can be provided in the FIFO 132′. For example, an area from the starting address “0000” to an address “0010” is set as the private area of the master 20A and an area from the end address “1000” to an address “0110” is set as the private area of the master 20B. Thus, the above-described dead lock is avoided.

As described so far, according to this embodiment, since instructions respectively issued by the two masters 20A and 20B are stored in the common FIFO 132′, the storage area is more efficiently used for storing the instructions than in Embodiment 1. In other words, in the case where an instruction group issued by one master is comparatively short, a comparatively long instruction group issued by another master is stored in the FIFO 132′.

Furthermore, when the effective storage area of the FIFO 132′ is adjusted, the capacity of the FIFO is filled up every time an arbitrary quantity of instructions are issued, so that timing for supplying instructions to functional blocks (see FIG. 4) can be changed. When, for example, the quantity of issued instructions is small, the number of stages of buffers for the instructions is made one by reducing the FIFO capacity, so that the instructions can be supplied without buffering. It is noted that the register 133 may be omitted when there is no need to adjust the FIFO capacity.

Embodiment 3

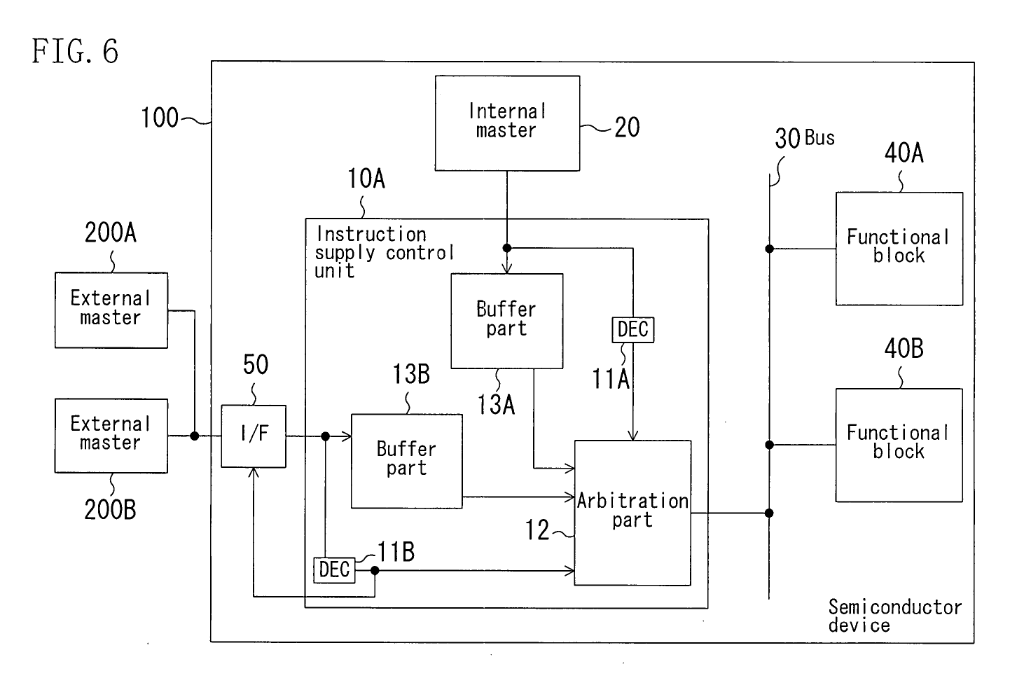

FIG. 6 schematically shows the architecture of a semiconductor device according to Embodiment 3 of the invention. The semiconductor device 100 of this embodiment includes the instruction supply control unit 10A of Embodiment 1, an internal master 20 such as a CPU (Central Processing Unit) or a DSP (Digital Signal Processor), an internal bus 30, functional blocks 40A and 40B serving as slaves, and an interface unit 50 for receiving instructions from external masters. The internal bus 30 is connected to the instruction supply control unit 10A and the functional blocks 40A and 40B. Also, the interface unit 50 is connected to the external masters 200A and 200B such as a CPU. The architecture of the semiconductor device 100 of FIG. 6 is shown merely as an example and it goes without saying that the numbers of the internal masters and the functional blocks may be different from those shown in FIG. 6. Also, an arbitrary number of external masters can be connected to the interface unit 50.

The semiconductor device 100 has a one chip architecture obtained with the master 20B of the system shown in FIG. 1 replaced with the interface unit 50. Now, the interface unit 50 will be described in detail.

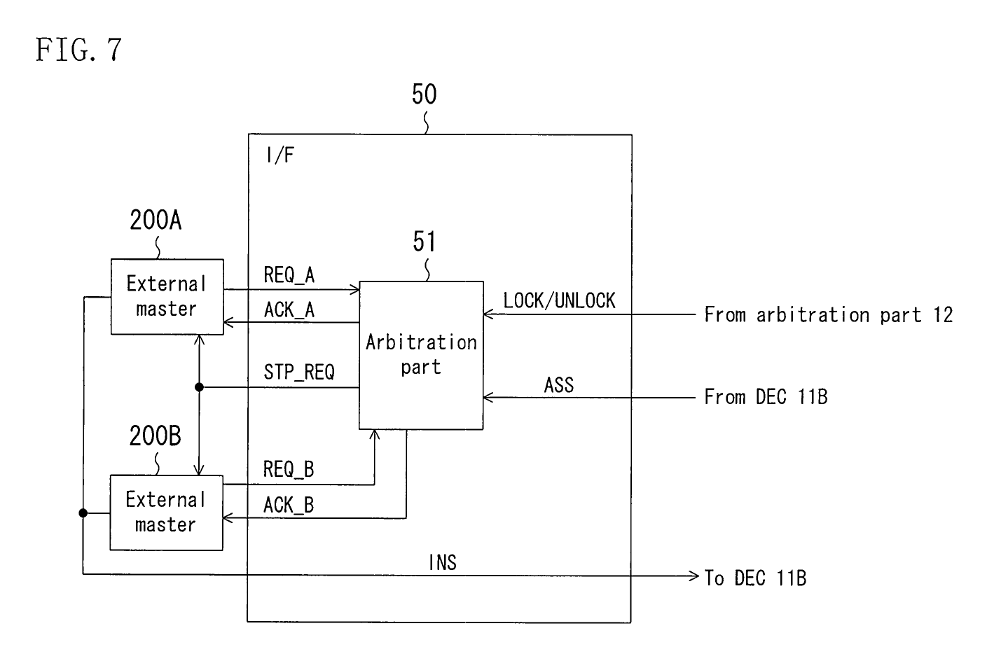

FIG. 7 shows the internal architecture of the interface unit 50. The interface unit 50 includes an arbitration part 51 for arbitrating the access to the inside of the semiconductor device 100 between the external masters 200A and 200B. The arbitration part 51 gives an access right to make an access to the inside of the semiconductor device 100 to one of the external masters 200A and 200B. Merely the external master that has thus obtained the access right can supply instructions to the functional blocks 40A and 40B by using the internal bus 30. The arbitration part 51 does not give the access right to another external master until it receives a signal ASS from the decoder 11B. Thus, switching of the access right between the external masters is performed with respect to each instruction group.

The instruction supply control unit 10A receives instruction codes INS through the interface unit 50 from the external master selected by the interface unit 50. The use right to use the internal bus 30 is given to one of the selected external master and the internal master 20 in the same manner as described in Embodiment 1.

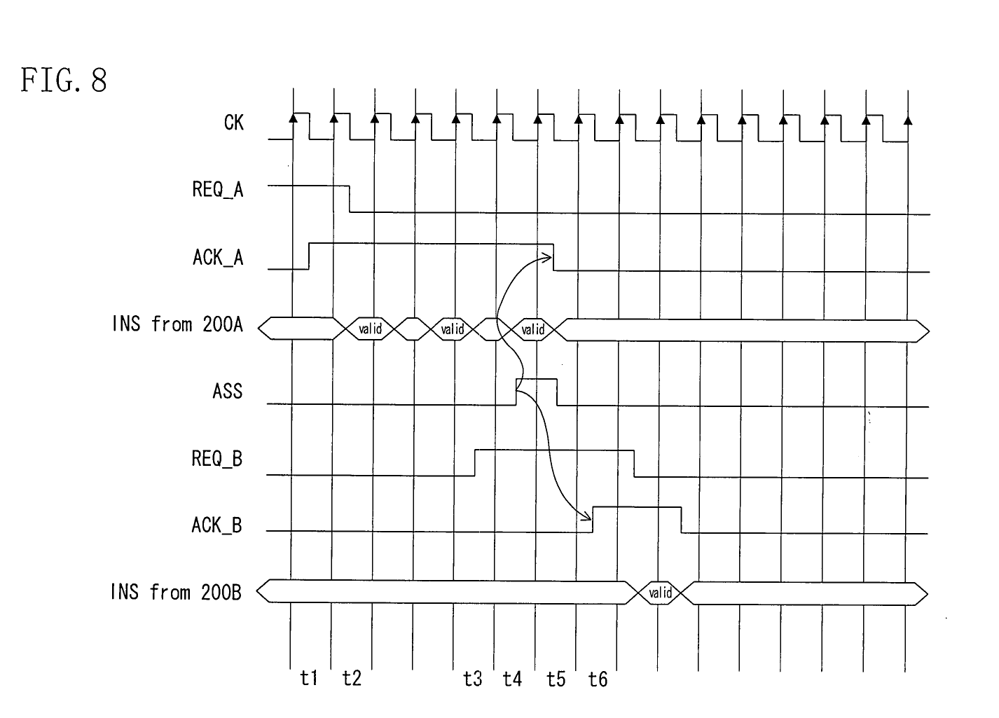

Next, the operation of the interface unit 50 will be described with reference to FIG. 8. It is herein assumed that each signal is being asserted when it is at High level.

The interface unit 50 is operated in synchronization with a system clock CK. First, when the external master 200A asserts a request signal REQ_A while the external master 200B is not making an access to the interface unit 50, the interface unit 50 asserts an acknowledge signal ACK_A for the external master 200A (at time t1). When the external master 200A receives the acknowledge signal ACK_A, it negates the request signal REQ_A (at time t2) and issues three instruction codes (which are shown as “valid” in FIG. 8) continuous as one instruction group. During this operation, even when the external master 200B asserts a request signal REQ_B (at time t3), the interface unit 50 does not assert an acknowledge signal ACK_B for the external master 200B.

When the third instruction code INS is supplied from the external master 200A to the instruction supply control unit 10A, the decoder 11B asserts the signal ASS corresponding to detection of the end of the instruction group (at time t4). When the interface unit 50 receives the signal ASS, it negates the acknowledge signal ACK_A (at time t5) and asserts the acknowledge signal ACK_B (at time t6). In this manner, the access right to access the inside of the semiconductor device 100 is shifted from the external master 200A to the external master 200B, and thereafter, an instruction code INS (which is shown as “valid” in FIG. 8) issued by the external master 200B is captured as effective data by the semiconductor device 100. In the exemplified operation shown in FIG. 8, the instruction group issued by the external master 200 is consisting of one instruction code, and when this instruction code is supplied to the instruction supply control unit 10A, the decoder 11B asserts the signal ASS.

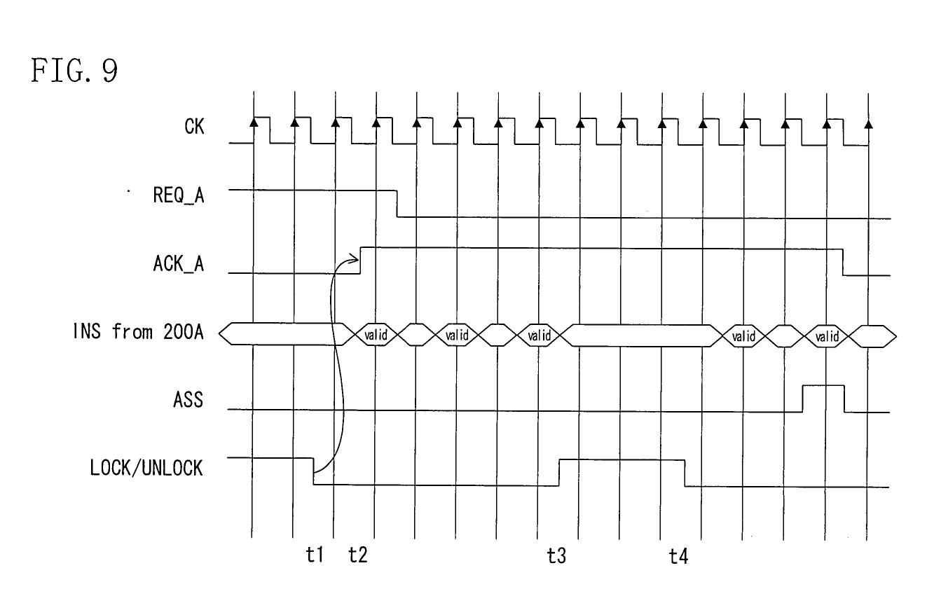

The operation of the interface unit 50 performed when the instruction supply control unit 10A asserts a signal LOCK will now be described with reference to another timing chart of FIG. 9.

First, when the signal LOCK is being asserted, the interface unit 50 does not assert the acknowledge signal ACK_A for the external master 200A even if the external master 200A asserts the request signal REQ_A. The interface unit 50 asserts the acknowledge signal ACK_A for the external master 200A only when the signal LOCK is negated, namely, when a signal UNLOCK is asserted (at time t1).

When the external master 200A receives the acknowledge signal ACK_A, it continuously issues instruction codes INS as one instruction group. If the signal LOCK is asserted during this issue (at time t3), the interface unit 50, and more specifically, the arbitration part 51 asserts a signal STP_REQ for requesting stop of the instruction issue of the external master 200A. Thus, the instruction issue from the external master 200A is temporarily suspended. However, the acknowledge signal ACK_A is being asserted during this suspension, and hence, the access right to access the inside of the semiconductor device 100 is kept by the external master 200A without being shifted to the external master 200B. Then, when the signal UNLOCK is asserted (at time t4), the external master 200A resumes the instruction issue.

As described so far, according to this embodiment, the switching of the access right to access the semiconductor device 100 between the external masters 200A and 200B is performed with respect to each instruction group, resulting in guaranteeing the successiveness and the continuity of the processing of each instruction group. Although the access right is switched between the two external masters 200A and 200B in the semiconductor device 100 of this embodiment, this does not limit the invention. According to the present invention, the access right is switched with respect to each instruction group among three or more external masters.

Although the semiconductor device 100 of this embodiment includes the instruction supply control unit 10A of Embodiment 1, it goes without saying that the instruction supply control unit 10B of Embodiment 2 can be used instead.

The instruction supply control unit of this invention switches the bus use right between respective masters with respect to each instruction group in a system in which two or more masters issue instructions to a plurality of functional blocks connected to one bus. Accordingly, the present invention is useful in a system including a plurality of masters each requesting continuous instruction execution.

1. An instruction supply control unit for appropriately selecting a master to be given a bus use right from a plurality of masters and supplying instructions issued by said selected master to said bus, comprising:
an instruction group end detection part for detecting an end of an instruction group composed of a batch of instructions issued by said selected master; and
an arbitration part for giving the bus use right to said selected master until the end of said instruction group is detected by said instruction group end detection part.

2. The instruction supply control unit of claim 1,
wherein each instruction issued by said plurality of masters includes an instruction end bit indicating whether or not said instruction is an end of a corresponding instruction group, and
said instruction group end detection part detects the end of said instruction group when said instruction end bit has a given value.

3. The instruction supply control unit of claim 1, further comprising a buffer part for storing instructions issued by each of said plurality of masters,
wherein when said instruction group end detection part detects the end of said instruction group, said arbitration part reads said instructions stored in said buffer part, supplies said read instructions to said bus and releases the bus use right of said selected master having issued said instructions.

4. The instruction supply control unit of claim 3,
wherein instructions issued by two masters are supplied to said bus, and
said buffer part includes a FIFO that stores instructions issued by one of said two masters from a starting address in the order of increasing addresses and stores instructions issued by the other of said two masters from an end address in the order of reducing addresses.

5. The instruction supply control unit of claim 3,
wherein said buffer part includes a register for adjusting an effective storage area of said buffer part.

6. A semiconductor device comprising:
at least one internal master;
an internal bus;
at least one functional block connected to said internal bus;
an interface unit for appropriately selecting an external master to be given an access right to access said semiconductor device from a plurality of external masters connected to said semiconductor device; and
an instruction supply control unit for appropriately selecting a master to be given an internal bus use right from said at least one internal master and said external master selected by said interface unit and supplying instructions issued by said selected master to said internal bus,
wherein said instruction supply control unit includes:
an instruction group end detection part for detecting an end of an instruction group composed of a batch of instructions issued by said selected master; and
an arbitration part for giving the internal bus use right to said selected master until said instruction group end detection part detects the end of said instruction group, and
said interface unit gives said selected external master the access right to access said semiconductor device until said instruction group end detection part detects an end of an instruction group issued by said selected external master.

7. The semiconductor device of claim 6,
wherein each instruction issued by said at least one internal master and said external master selected by said interface unit includes an instruction end bit indicating whether or not said instruction is an end of a corresponding instruction group, and
said instruction group end detection part detects the end of said instruction group when said instruction end bit has a given value.

8. The semiconductor device of claim 6, further comprising a buffer part for storing instructions issued by each of said at least one internal master and said external master selected by said interface unit,
wherein when said instruction group end detection part detects the end of said instruction group, said arbitration part reads said instructions stored in said buffer part, supplies said read instructions to said internal bus and releases the internal bus use right of said selected master having issued said instructions.
